(19) United States
(12) Patent Application Publication
(10) Pub. No.: US 2023/0358087 A1
(43) Pub. Date: Nov. 9, 2023

(54) FURNITURE DRIVE

(71) Applicant: Julius Blum GmbH, Hoechst (AT)

(72) Inventor: Klaus KROESS, Dornbirn (AT)

(21) Appl. No.: 18/222,120

(22) Filed: Jul. 14, 2023

Related U.S. Application Data
(63) Continuation of application No. PCT/AT2022/060022, filed on Jan. 25, 2022.

(30) Foreign Application Priority Data
Jan. 27, 2021 (AT) A 50040/2021

(51) Int. Cl. E05D 7/10; E05D 3/02; E05F 1/10; E05D 13/00

(52) U.S. Cl. CPC E05D 7/1061; E05D 3/02; E05F 1/1041; E05D 13/1207; E05Y 2201/624; E05Y 2600/528; E05Y 2900/20

(57) ABSTRACT

A furniture drive includes base body to be fixed to a furniture carcass, an actuating arm to be fixed to a movable furniture part, and a locking device for locking the actuating arm to the base body. The locking device includes a locking element movable between a locking position, in which the actuating arm is locked to the base body, and a demounting position, in which the actuating arm can be demounted from the base body. An actuating device can preferably be actuated with a tool, for moving the locking element from the locking position into the demounting position. The furniture drive includes a releasable securing device configured to prevent a movement of the locking element from the locking position into the demounting position upon an actuation of the actuating device.

### BACKGROUND OF THE INVENTION

The present invention relates to a furniture drive for movably supporting a furniture part relative to a furniture carcass. The furniture drive includes at least one base body configured to be fixed to and/or within the furniture carcass, at least one actuating arm configured to be fixed to the movable furniture part, and at least one locking device for locking the at least one actuating arm to the at least one base body. The at least one locking device includes at least one locking element movable between a locking position, in which the at least one actuating arm is locked to the at least one base body, and a demounting position, in which the at least one actuating arm can be demounted from the at least one base body. The furniture drive further includes at least one actuating device, preferably configured to be actuated with the aid of a tool, for moving the at least one locking element from the locking position into the demounting position.

Moreover, the invention concerns an item of furniture comprising a furniture carcass, a furniture part movably supported relative to the furniture carcass, and at least one furniture drive to the type to be described.

A furniture drive comprising a base body and an actuating arm configured to be releasably fixed to the base body is disclosed in the WO 2006/053352 A1 reference, for example. The separate configuration between the base body and the actuating arm has the particular advantage that the constructional size of the furniture drive can be divided into two constructional units, and that different types of base bodies can be combined with different types of actuating arms.

A drawback of known constructions is the fact that upon a release of the locking between the base body and the actuating arm, there is also the danger that the operator will be surprised by the suddenly released weight of the furniture part connected to the actuating arm, and the actuating arm with the furniture part can no longer be held by the operator. This can lead to a crash of the furniture part and to damages to the furniture part, to injuries of the assembling personnel and damages to objects.

### SUMMARY OF THE INVENTION

It is an object of the present invention to provide a furniture drive of the type mentioned in the introductory part, thereby avoiding the above-discussed drawbacks. In particular, the safety for an operator shall be increased.

According to the invention, the furniture drive includes at least one releasable securing device configured to prevent a movement of the at least one locking element from the locking position into the demounting position upon an actuation of the actuating device.

In other words, a releasable securing device is provided, the releasable securing device preventing a release of the locking, even when the actuating device for moving the locking element into the demounting position is actuated, for example with the aid of a tool. For a successful separation between the base body and the actuating arm, at least one further action is thus required for an operator.

This further action can be, for example, an additional relative movement, in particular a lifting movement, of the actuating arm relative to the base body. Only after an additional relative movement of the actuating arm, initiated by the operator, a movement of the locking element into the demounting position can be made possible.

According to an embodiment, the releasable securing device includes at least one bearing contour configured to bear against the at least one locking element under an influence of a force of gravity acting to the at least one actuating arm, and possibly under an influence of a force of gravity of the furniture part to be fixed to the at least one actuating arm.

According to possible embodiments:
the at least one bearing contour is liftable from the at least one locking element by a movement of the at least one actuating arm against the force of gravity, and/or
the at least one bearing contour includes at least one recess in which the at least one locking element can be at least partially arranged, and/or
the at least one actuating arm has a first end to which the movable furniture part can be fixed, and a second end on which the at least one bearing contour is arranged.

### BRIEF DESCRIPTION OF THE DRAWINGS

Further details and advantages of the present invention will be explained with the aid of the embodiments shown in the drawings, in which:

FIG. 1a, 1b show an item of furniture comprising a movable furniture part and two furniture drives for moving the movable furniture part, and the item of furniture with the furniture part removed,

FIG. 2a, 2b show a furniture drive in two different perspective views, in which the base body and the actuating arm are separated from each other,

FIG. 3a, 3b show the mounting operation of the actuating arm to the base body in two subsequent steps,

FIG. 4a-4c show the mounting operation of the actuating arm on the base body in two further subsequent steps,

FIG. 5a, 5b show the furniture drive with a force adjustment device for adjusting a force to the actuating arm, and an additional actuating device for releasing the locking between the base body and the actuating arm,

FIG. 6a, 6b show a side view of the furniture drive and an enlarged detail view thereof, in which a movement of the locking element into the demounting position is prevented by a releasable securing device,

FIG. 7a, 7b show a side view of the furniture drive and an enlarged detail view thereof, in which a movement of the locking element into the demounting position is unblocked by the releasable securing device,

FIG. 8a, 8b show a side view of the furniture drive and an enlarged detail view thereof, in which a movement of the locking element into the demounting position is prevented by a slightly modified releasable securing device,

FIG. 9a, 9b show a side view of the furniture drive and an enlarged detail view thereof, in which a movement of the locking element into the demounting position is unblocked by the slightly modified releasable securing device according to FIGS. 8a, 8b.

### DETAILED DESCRIPTION OF THE INVENTION

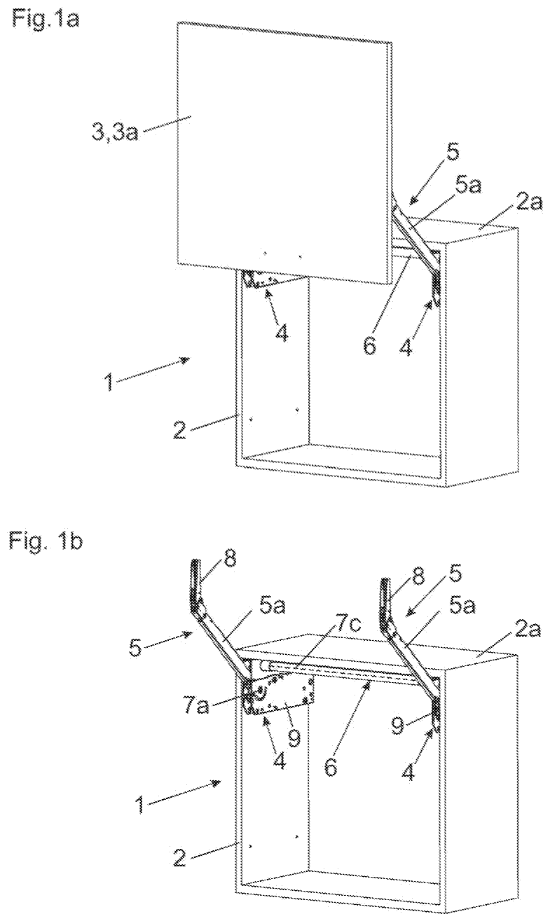

FIG. 1a shows an item of furniture 1 comprising a furniture carcass 2 and a movably-supported furniture part 3, the furniture part 3 being in the form of a furniture flap 3a elevatable relative to the furniture carcass 2. The movable furniture part 3 can have a one-piece configuration or, as an alternative, can also include two or more movable furniture parts 3.

A furniture drive 4 for moving the movable furniture part 3 is fixed to each of the opposing sidewalls of the furniture carcass 2. Each of the furniture drives 4 includes at least one pivotally supported actuating arm 5, and a pivoting movement of the two actuating arms 5 can be synchronized to one another via a pivotable synchronization shaft 6.

FIG. 1b shows the item of furniture 1 according to FIG. 1a with the furniture part 3 removed. The two furniture drives 4 can be configured identical in construction, so that the explanations provided here can be applied to both furniture drives 4.

The furniture drive 4 includes a, preferably substantially cuboidal, base body 9 configured to be fixed to the furniture carcass 2, and a lever 5a of the actuating arm 5 is pivotally supported about a pivoting axis 7a on the base body 9.

On the contrary, the synchronization shaft 6 is rotatably supported about a further pivoting axis 7c. The pivoting axis 7a of the lever 5a and the further pivoting axis 7c of the synchronization shaft 6 are arranged laterally offset to one another, preferably mutually spaced apart from each other in a parallel relationship.

The offset arrangement between the pivoting axis 7a of the lever 5a and the further pivoting axis 7c of the synchronization shaft 6 has the particular advantage that the synchronization shaft 6 can be arranged on a high location within the furniture carcass 2, that is to say adjacent to a top panel 2a of the furniture carcass 2. Therefore, an increased storage space can be made available within the furniture carcass 2.

Further, it can be provided that the further pivoting axis 7c, in a mounted condition of the furniture drive 4, can be arranged deeper in a direction of the depth of the furniture carcass 2, in comparison with a coaxial arrangement between the pivoting axis 7a and the further pivoting axis 7c.

The actuating arm 5 can include a fitting portion 8 configured to be releasably connected to a fitting body (not shown) to be fixed to the furniture part 3. The fitting portion 8 can be hingedly connected to the lever 5a of the actuating arm 5, and can be configured to be connected to the fitting body to be fixed to the furniture part 3 without the use of a tool.

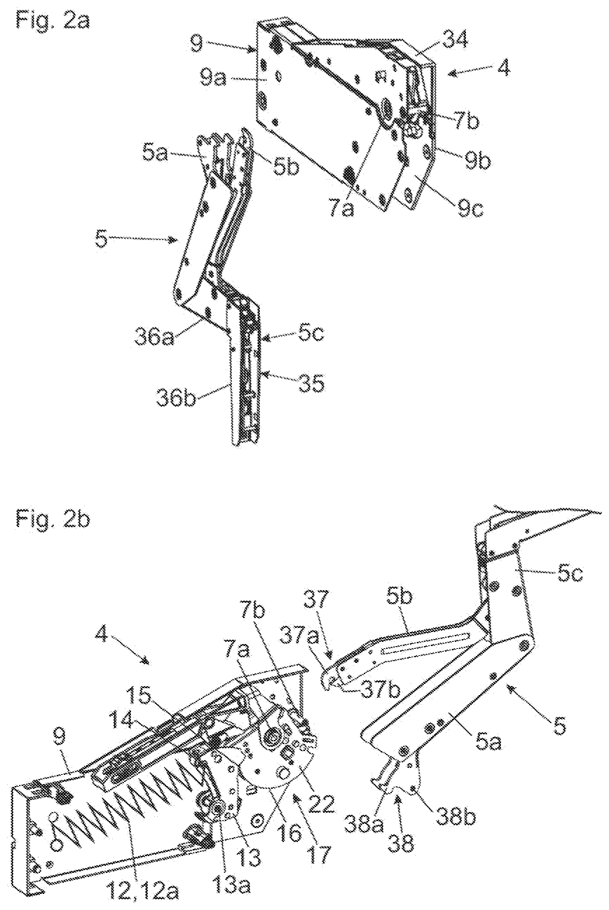

FIG. 2a shows the furniture drive 4 for moving the movable furniture part 3, in which the actuating arm 5 and the base body 9 are separated from each other.

The base body 9 of the furniture drive 4 includes two housing walls 9a, 9b mutually spaced apart from each other in a parallel relationship, each of the housing walls 9a, 9b having a flat-shaped bearing surface configured to bear against a furniture carcass 2. In this way, the base body 9 of the furniture drive 4 can be fixed either to a first sidewall of the furniture carcass 2 or, alternatively, to a second sidewall of the furniture carcass 2, the second sidewall opposing the first sidewall of the furniture carcass 2.

A front opening 9c is formed between the two housing walls 9a, 9b of the furniture drive 4, and the actuating arm 5 at least partially protrudes through the front opening 9c in a maximum open position.

In a mounted condition, the actuating arm 5 is pivotally supported about at least one pivoting axis 7a on the base body 9.

In the shown embodiment, the actuating arm 5 includes a plurality of levers 5a, 5b, 5c hingedly connected to each other, and at least two of the levers 5a, 5b of the actuating arm 5 are releasably connectable to the base body 9 of the furniture drive 4.

The actuating arm 5 is movable between a closed position and a maximum open position, and the actuating arm 5 is at least partially arranged within the base body 9 of the furniture drive 4 in the closed position.

The levers 5a, 5b, 5c of the actuating arm 5 can form a four-joint geometry, and one of the four pivot points of the four-joint geometry corresponds to the at least one pivoting axis 7a of the actuating arm 5.

In the shown embodiment, the actuating arm 5 is pivotally supported about at least one second pivoting axis 7b on the base body 9, wherein
the base body 9 of the furniture drive 4 has a front opening 9c, and the actuating arm 5 at least partially protrudes through the front opening 9c at least in a maximum open position, and the second pivoting axis 7b has a smaller perpendicular distance to the front opening 9c than the first pivoting axis 7a, and/or
the base body 9 of the furniture drive 4 has an upper side 34 which, in a fixed condition of the furniture drive 4 on the furniture carcass 2, faces towards a top panel 2a (FIG. 1a, 1b) of the furniture carcass 2, the second pivoting axis 7b having a smaller perpendicular distance to the upper side 34 than the second pivoting axis 7b.

According to an embodiment, the second pivoting axis 7b corresponds to a pivot point of the four-joint geometry of the levers 5a, 5b, 5c of the actuating arm 5.

Further, the following arrangements are possible:
at least two of the provided levers 5a, 5b of the actuating arm 5, in at least one pivoting position, preferably in each pivoting position, of the actuating arm 5 are nested into one another, so that the two levers 5a, 5b, in a view from the side, are configured without a gap to one another, and/or
at least one lever 5a, 5c, in a cross-section, is configured to be U-shaped and a further lever 5b can be arranged or is arranged at least partially between the vertical limbs of the U-shape.

A fastening interface 35 is arranged on the third lever 5c, and the movable furniture part 3 can be, preferably releasably, fixed to the actuating arm 5 via the fastening interface 35. The first lever 5a and the second lever 5b are hingedly connected to the third lever 5c. The third lever 5c has an angled configuration, and two partial portions 36a, 36b of angled third lever 5c enclose an angle of substantially 90° relative to each other.

FIG. 2b shows the furniture drive 4 in a further perspective view, in which the housing wall 9a is hidden.

The furniture drive 4 includes at least one force storage member 12 for applying a force to the actuating arm 5. Preferably, the at least one force storage member 12 is arranged on the base body 9 and preferably includes at least one spring element 12a. In this way, a weight of the movable furniture part 3 to be fixed to the actuating arm 5 can be compensated for.

In FIG. 2b, the force storage member 12 is only schematically depicted and can include, besides mechanical spring elements (in particular helical springs), also a gas pressure spring for example. As an alternative or in addition to the force storage member 12, an electric drive for driving the actuating arm 5 can also be provided.

According to an embodiment, a transmission mechanism 17 is provided, the transmission mechanism 17 being configured to transmit a force that can be stored in the at least one force storage member 12 to the actuating arm 5. Preferably, the transmission mechanism 17:
includes at least one intermediate lever 13 pivotable about a pivoting axis 13a, preferably wherein the at least one force storage member 12 is connected to the at least one intermediate lever 13 via an, preferably adjustable, engagement location 14, and/or
includes at least one pressure portion 15, preferably a rotatable pressure roller, and at least one setting contour 16 on which the at least one pressure portion 15 can be displaceably supported upon a movement of the actuating arm 5, preferably wherein the at least one pressure portion 15 is arranged or can be arranged on the at least one intermediate lever 13 of the transmission mechanism 17, and the at least one setting contour 16 is arranged or can be arranged on the actuating arm 5, or vice versa.

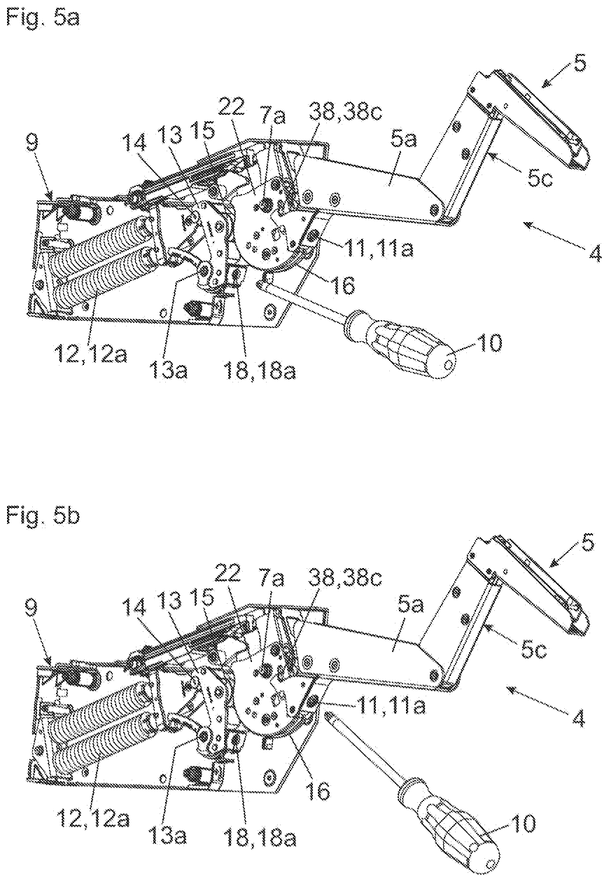

In the shown embodiment, the actuating arm 5 is configured to be releasably connected to the base body 9 of the furniture drive 4 via two locking devices 37, 38 separate from each other. At least one of the two locking devices 37, 38 can include at least one fastening portion 37a, 38a configured to be hung into or configured to be slid into the base body 9, and/or can include at least one locking element 37b pressurized by at least one spring 25 (FIG. 5a).

A first, preferably hook-shaped, fastening portion 37a of the lever 5b can be hung into the base body 9, for example to a pin arranged on the second pivoting axis 7b. The lever 5b can be releasably locked by the spring-loaded locking element 37b.

The second fastening portion 38a of the other locking device 38, in contrast, can be releasably locked to a movable actuating portion 22, the actuating portion 22 being preferably pivotable about the first pivoting axis 7a. Preferably, the setting contour 16 is formed on the movable actuating portion 22.

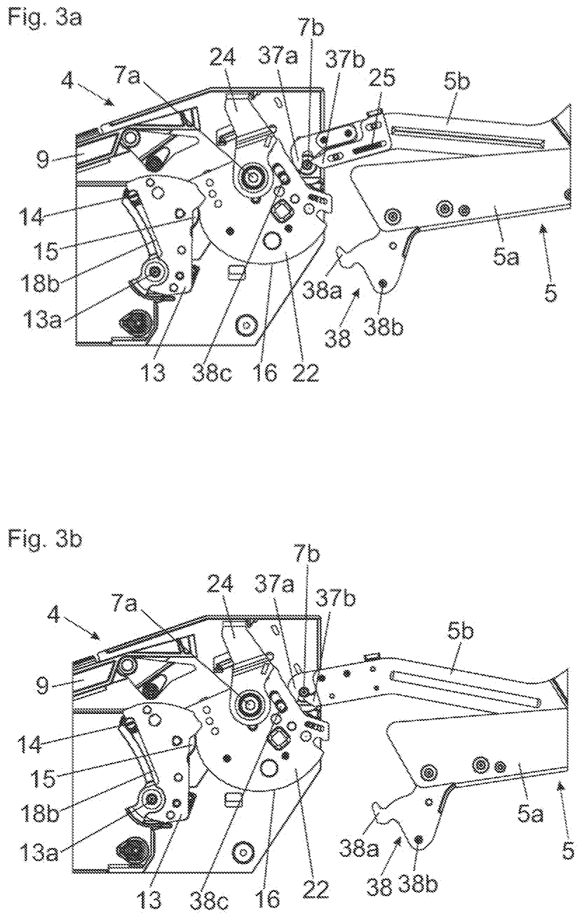

FIG. 3a shows the mounting operation of the actuating arm 5 to the base body 9 in a first step, in which the fastening portion 37a of the locking device 37 is hung to the pin arranged on the second pivoting axis 7b.

To be seen is the locking element 37b which, for example, is linearly displaceably supported along at least one guide, and is pre-stressed in a direction of the locking position by a spring 25. For example, the spring 25 can be formed by a mechanical spring element or also by a material elasticity of a component. It can be seen that the locking element 37b includes an inclined surface for urging the locking element 37b against the force of the spring 25 upon a co-operation with the hinge axis 7b.

FIG. 3b shows the locking element 37b locked to the pivoting axis 7b. The locking element 37b has been moved from the position shown in FIG. 3a due to its inclined surface against the force of the spring 25. Subsequently, the locking element 37b has been brought into a locking position with the pivoting axis 7b by a force of the relaxing spring 25. The lever 5b is now pivotally connected to the pivoting axis 7b.

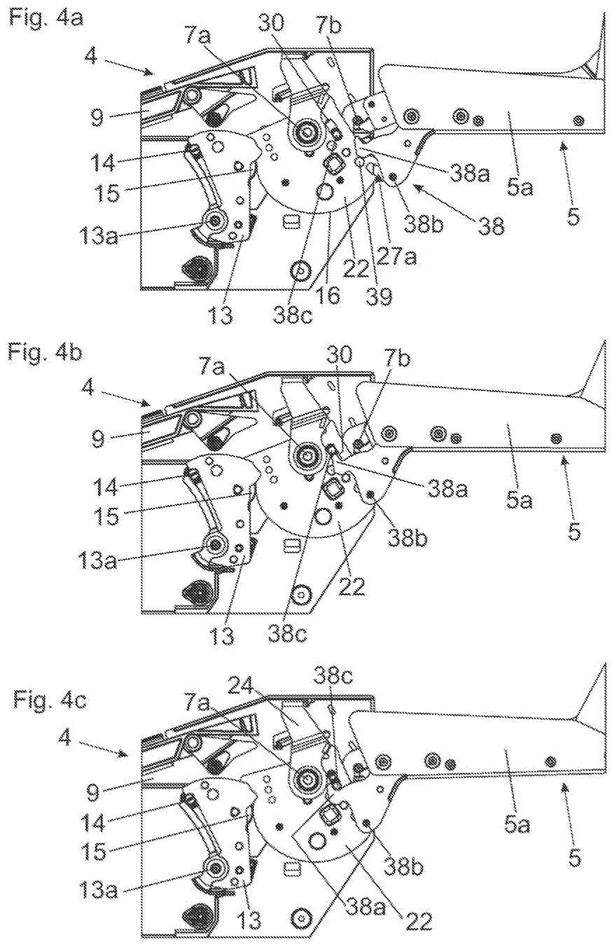

FIG. 4a-4c show the mounting operation of the actuating arm 5 to the base body 9 in further steps. Starting from the position according to FIG. 3b, the levers 5a, 5b have been pivoted relative to the base body 9 about the pivoting axis 7b (FIG. 4a). The fastening portion 38a of the locking device 38 is supportable on a guide element 39 arranged on the actuating portion 22, and the laterally protruding locking element 38b of the lever 5a can be introduced into the recess 27a of the actuating portion 22.

In FIG. 4b, it can be seen that the movable locking element 38c is movable along the guide 30 by the fastening portion 38a of the lever 5a against a force of a spring 25 (not shown here).

In FIG. 4c, it can be seen that the locking element 38c can enter into a locking recess of the fastening portion 38a due to the contour formed by the fastening portion 38a and due to a force of a loaded spring 25. As a result, the lever 5a can be releasably locked to the base body 9.

FIG. 5a shows the furniture drive 4 in a perspective view, in which the actuating arm 5 is connected to the base body 9 of the furniture drive 4 via at least one locking device 38.

The at least one locking device 38 includes a locking element 38c configured to be moved between a locking position, in which the at least one actuating arm 5 is locked to the at least one base body 9, and a demounting position, in which the at least one actuating arm 5 can be demounted from the at least one base body 9.

The furniture drive 4 can include a force adjustment device 18 for adjusting a force of the force storage member 12 to the at least one actuating arm 5. Preferably, the force adjustment device 18:
includes at least one rotatably supported adjustment wheel 18a, and a force of the force storage member 12 acting onto the at least one actuating arm 5 is adjustable by rotating the adjustment wheel 18a, and/or
includes at least one threaded spindle 18b (FIG. 3a, 3b) along which an engagement location 14 of the force storage member 12 is movable upon an actuation of the force adjustment device 18, and/or
the base body 9 includes a front face having at least one front opening 9c (FIG. 2) through which the at least one actuating arm 5 projects in an open position, and an adjustment wheel 18a of the force adjustment device 18 is actuable through the front opening 9c from a direction extending transversely to the front face.

FIG. 5b shows that the actuating drive 4 further includes at least one actuating device 11, preferably to be actuated with the aid of a tool 10, for moving the at least one locking element 38c from the locking position into a demounting position. In the demounting position, the actuating arm 5 can be de demounted from the base body 9.

The actuating device 11 can include an opening 11a for introducing the tool 10, and the locking element 38c is movable into the demounting position by exerting a force to the locking element 38c against a resilient action.

For an operator, there are two different possibilities for introducing the tool 10. On the one hand, the rotatable adjustment wheel 18a of the force adjustment device 18 can be actuated.

On the other hand, the locking between the actuating arm 5 and the base body 9 can be released by an actuation of the actuating device 11. If thus the operator inadvertently actuates the actuating device 11 instead of the force adjustment device 18, the locking between the base body 9 and the actuating arm 5 could be inadvertently released. A crash of the actuating arm 5 along with the movable furniture part 3 would be the result.

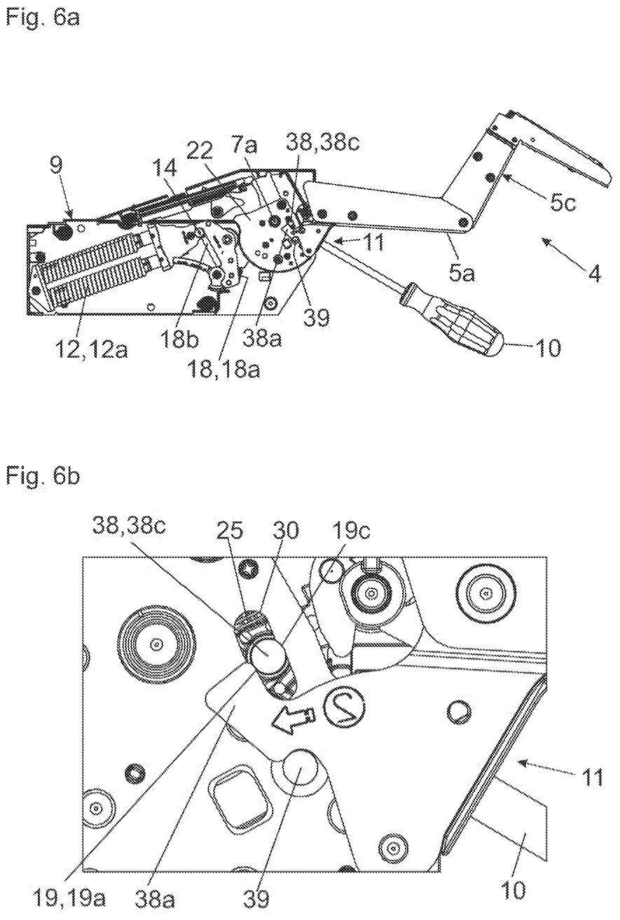

FIG. 6a shows the furniture drive 4 in a side view, in which the operator tries to actuate the locking element 38c of the locking device 38 against the force of the spring 25 (FIG. 6b) by introducing the tool 10 into the opening 11 a (FIG. 5a, 5b) of the actuating device 11.

FIG. 6b shows the region of the locking element 38c according to FIG. 6a in an enlarged view. It can be seen that the fastening portion 38a of the actuating arm 5 is received between the stationary guide element 39 (preferably in the form of a cylindrical pin) and the movable guide element 38c of the locking device 38.

The furniture drive 4 includes, in addition to the locking device 38, a releasable securing device 19 configured to prevent a movement of the at least one locking element 38c from the locking position into the demounting position upon an actuation of the actuating device 11.

The releasable securing device 19 can include at least one bearing contour 19a configured to bear against the at least one locking element 38c under an influence of gravity on the at least one actuating arm 5 and possibly under an influence of a weight force of the furniture part 3 to be fixed to the at least one actuating arm 5.

According to an embodiment:
the at least one bearing contour 19a is liftable from the at least one locking element 38c by a movement of the at least one actuating arm 5 against the force of gravity, and/or
the at least one bearing contour 19a includes at least one recess 19c in which the at least one locking element 38c can be at least partially arranged, and/or
the at least one actuating arm 5 has a first end configured to be fixed to the movable furniture part 3, and a second end on which the at least one bearing contour 19a is arranged.

In the shown embodiment, the guide 30 for movably supporting the locking element 38c, together with the fastening portion 38a of the actuating arm 5, jointly form a common bearing contour 19a for the locking element 38c.

Therefore, if a person tries to push the locking element 38c out from the locking position by exerting a force with the aid of the tool 10, a movement of the locking element 38c in a direction of the demounting position is prevented. The locking element 38c is namely arrested between the recess 19c and the fastening portion 38a of the actuating arm 5 and can thus not further be moved along the guide 30 into the demounting position. The locking between the base body 9 and the actuating arm 5, despite an actuation of the actuating device 11, is further maintained by the releasable securing device 19.

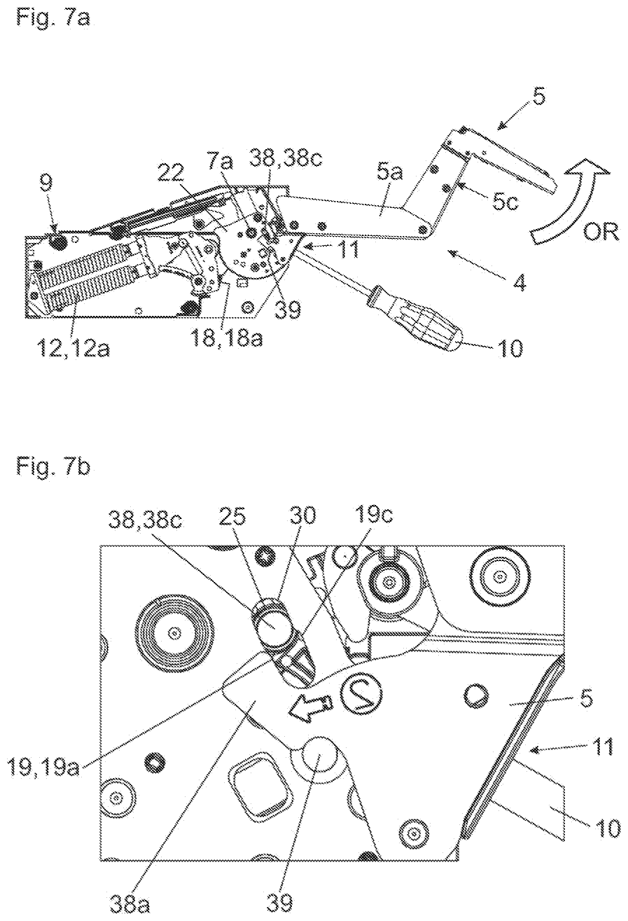

FIG. 7a shows the furniture drive 4 in a side view. For releasing the locking, the actuating arm 5 has firstly to be moved in the opening direction OR (thus in a direction of the depicted arrow).

FIG. 7b shows the region of the locking element 38c according to FIG. 7a in an enlarged view. By a movement of the actuating arm 5 in the opening direction OR, the fastening portion 38a of the actuating arm 5 is tilted about the guide element 39 in a counter-clockwise direction, thereby releasing the locking element 38c from the recess 19c of the bearing contour 19a. Only now, a movement of the locking element 38c along the guide 30 into the demounting position is possible in order for the actuating arm 5 to be demounted from the base body 9 of the furniture drive 4.

According to possible embodiments, the guide 30:
is at least partially configured as an elongated hole, and/or
is arranged on the base body 9, preferably on a pivotable actuating portion 22, of the base body 9, and/or
includes at least one recess 19c in which the at least one locking element 38c can be at least partially arranged.

With further embodiments, the actuating device 11:
is configured to be actuated in an open position of the at least one actuating arm 5, and/or
is arranged on a front face, facing towards an operator in a mounted position, of the 10 furniture drive 4, and/or
includes at least one opening 11 a for introducing a tool 10, and the at least one locking element 38c is configured to be actuated with the aid of the tool 10 introduced into the opening 11a.

With further embodiments:
the at least one locking device 38 includes at least one fastening portion 38a arranged on the actuating arm 5, the fastening portion 38a being configured to be hung into and/or configured to be slid into the base body 9 of the furniture drive 4, and/or
the at least one locking device 38 includes at least one fastening portion 38a arranged on the actuating arm 5, the fastening portion 38a being received between the locking element 38c and a guide element 39 of the furniture drive 4 in a locked position of the actuating arm 5, and/or
the at least one locking device 38 includes at least one spring 25, the at least one spring being configured to push the at least one locking element 38c in a direction of the locking position, and/or
the at least one locking element 38c of the at least one locking device 38 is configured as a, preferably cylindrical, pin.

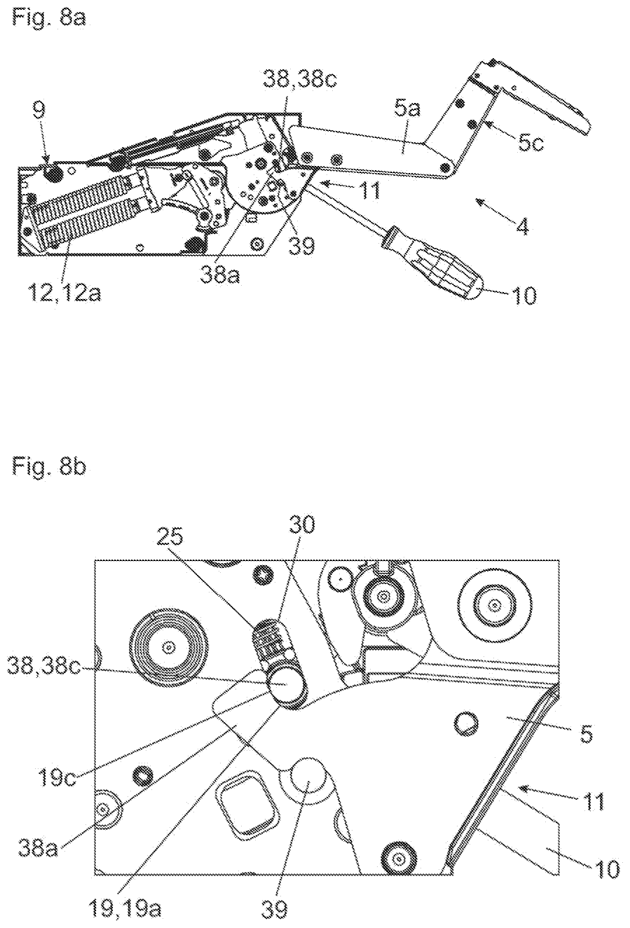

FIG. 8a shows a side view of the furniture drive 4 with the securing device 19 in a slightly modified embodiment.

FIG. 8b shows the region of the locking element 38c according to FIG. 8a, in which the recess 19c for partially receiving the locking element 38c is not arranged on the guide 30 as in the previous embodiment, but is rather arranged on the actuating arm 5. However, the functionality of the securing device 19 is basically identical.

In a locked condition of the actuating arm 5, the locking element 38c is received between the fastening portion 38a of the actuating arm 5 and the guide 30. A movement of the locking element 38c into the demounting position is prevented, because the locking element 38c is arrested between the recess 19c of the fastening portion 38a and the guide 30.

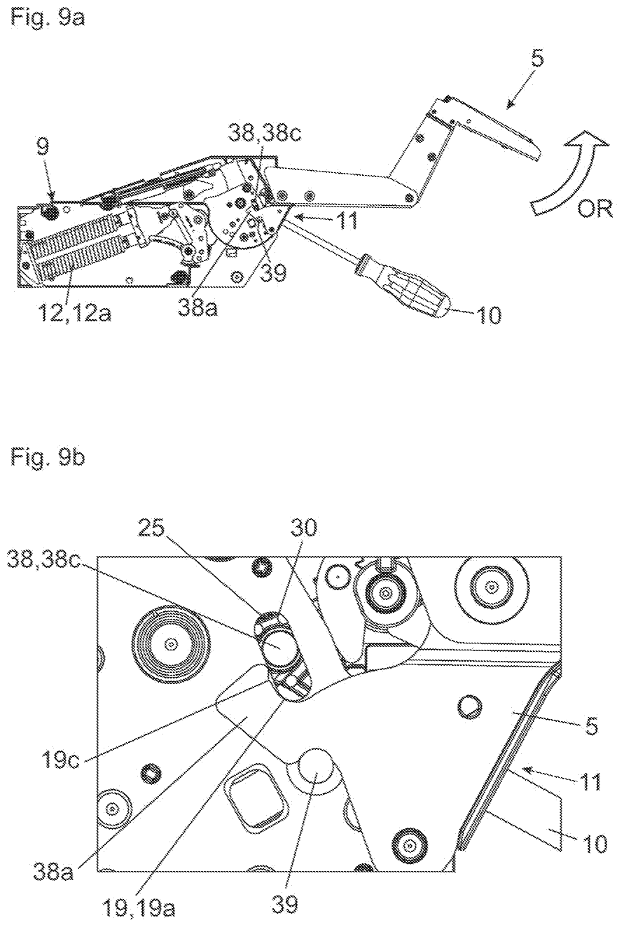

FIG. 9a shows the embodiment of the furniture drive 4 according to FIGS. 8a, 8b, in which the locking between the base body 9 and the actuating arm 5 can only be released by additionally lifting the actuating arm 5 in the opening direction OR.

FIG. 9b shows the region of the locking element 38c according to FIG. 9a. By lifting the actuating arm 5 in the opening direction OR, the fastening portion 38a is tilted about the guide element 39, preferably in the form of a cylindrical pin, in a counter-clockwise direction.

Due to the tilting movement of the fastening portion 38a about the axis formed by the guide element 39, the path for the locking element 38c into the demounting position along the guide 30 can be unblocked. Now, the locking element 38c can be moved against a force of the spring 25 into the demounting position by exerting a force with the aid of the tool 10 in order to demount the actuating arm 5 from the base body 9.

Accordingly, the actuating arm 5 can only be demounted from the base body 9 when the movable furniture part 3, in an open condition, is firstly moved further in the opening direction OR, and then the actuating device 11 for releasing the locking is to be actuated. This constitutes a significant safety aspect, because the operator must necessarily grasp the actuating arm 5 and/or the furniture part 3 connected therewith. Therefore, the movable furniture part 3 can be secured against a crash.

1. A furniture drive for movably supporting a furniture part relative to a furniture carcass, the furniture drive comprising:
at least one base body configured to be fixed to and/or within the furniture carcass,
at least one actuating arm configured to be fixed to the movable furniture part,
at least one locking device for locking the at least one actuating arm to the at least one base body, the at least one locking device including at least one locking element movable between a locking position, in which the at least one actuating arm is locked to the at least one base body, and a demounting position, in which the at least one actuating arm can be demounted from the at least one base body,
at least one actuating device, preferably configured to be actuated with the aid of a tool, for moving the at least one locking element from the locking position into the demounting position,
wherein the furniture drive includes at least one releasable securing device configured to prevent a movement of the at least one locking element from the locking position into the demounting position upon an actuation of the actuating device.

2. The furniture drive according to claim 1, wherein the releasable securing device includes at least one bearing contour, the at least one bearing contour being configured to bear against the at least one locking element 38c under an influence of a force of gravity acting to the at least one actuating arm and possibly under an influence of a weight force of the furniture part to be fixed to the at least one actuating arm.

3. The furniture drive according to claim 2, wherein:
the at least one bearing contour is liftable from the at least one locking element by a movement of the at least one actuating arm against the force of gravity, and/or
the at least one bearing contour includes at least one recess in which the at least one locking element can be at least partially arranged, and/or
the at least one actuating arm has a first end configured to be fixed to the movable furniture part, and a second end on which the at least one bearing contour is arranged.

4. The furniture drive according to claim 1, wherein the at least one locking element is movable between the locking position and the demounting position in and/or within a guide.

5. The furniture drive according to claim 4, wherein the guide:
is at least partially configured as an elongated hole, and/or
is arranged on the base body, preferably on a pivotable actuating portion of the base body, and/or
includes at least one recess in which the at least one locking element can be at least partially arranged.

6. The furniture drive according to claim 1, wherein the actuating device:
is configured to be actuated in an open position of the at least one actuating arm, and/or
is arranged on a front face of the furniture drive, the front face facing towards an operator in a mounted position of the furniture drive, and/or
includes at least one opening for introducing a tool, wherein the at least one locking element is configured to be actuated with the aid of the tool introduced into the opening.

7. The furniture drive according to claim 1, wherein:
the at least one locking device includes at least one fastening portion arranged on the actuating arm, the at least one fastening portion being configured to be hung into and/or being configured to be slid into the base body of the furniture drive, and/or
the at least one locking device includes at least one fastening portion arranged on the actuating arm, the at least one fastening portion being received between the at least one locking element and a guide element of the furniture drive in a locked condition of the actuating arm, and/or
the at least one locking device includes at least one spring, the at least one spring being configured to push the at least one locking element in a direction of the locking position, and/or
the at least one locking element of the at least one locking device is configured as a, preferably cylindrical, pin.

8. The furniture drive according to claim 1, wherein at least two locking devices separate from one another are provided for the releasable locking between the at least one base body and the at least one actuating arm, preferably wherein the at least one actuating arm is pivotable on the at least one base body about at least two pivoting axes separate from one another.

9. The furniture drive according to claim 1, wherein the furniture drive includes at least one force storage member, preferably supported on the base body, the at least one force storage member preferably having at least one helical spring, the at least one force storage member being configured to apply a force to the actuating arm so as to compensate for a weight of the furniture part to be fixed to the actuating arm.

10. The furniture drive according to claim 9, wherein a transmission mechanism is provided, the transmission mechanism being configured to transmit a force that can be stored in the force storage member to the actuating arm, preferably wherein the transmission mechanism:
includes at least one intermediate lever, preferably wherein the at least one force storage member is connected to the at least one intermediate lever via an, preferably adjustable, engagement location, and/or
includes at least one pressure portion, preferably a rotatable pressure roller, and at least one setting contour on which the at least one pressure portion can be displaceably supported upon a movement of the actuating arm, preferably wherein the at least one pressure portion is arranged or can be arranged on the at least one intermediate lever of the transmission mechanism, and the at least one setting contour is arranged or can be arranged on the actuating arm, or vice versa.

11. The furniture drive according to claim 9, wherein the furniture drive includes a force adjustment device for adjusting a force of the force storage member to the at least one actuating arm, preferably wherein the force adjustment device:
includes at least one rotationally-supported adjustment wheel, wherein a force of the force storage member acting onto the at least one actuating arm is adjustable by a rotating the adjustment wheel, and/or
includes at least one threaded spindle along which an engagement location of the force storage member is movable upon an actuation of the force adjustment device, and/or
that the base body has a front face having at least one front opening through which the at least one actuating arm projects in an open position, wherein an adjustment wheel of the force adjustment device is configured to be actuated through the opening from a direction extending transversely to the front face.

12. The furniture drive according to claim 1, wherein the actuating arm:
includes at least one fastening portion, preferably at least two fastening portions, configured to be hung into or configured to be slid into the base body, and/or
includes at least two or more levers hingedly connected to one another, and/or
includes at least one angled lever, preferably wherein two partial portions of the angled lever enclose an angle of substantially 90° relative top one another, and/or
includes at least one lever on which a fastening interface is arranged, the fastening interface being configured to, preferably releasably, fix the movable furniture part to the actuating arm.

13. The furniture drive according to claim 1, wherein the actuating arm is movable between a closed position and a maximum open position, wherein the actuating arm is at least partially arranged within the base body of the furniture drive in the closed position.

14. The furniture drive according to claim 1, wherein the furniture drive includes at least one movable, preferably pivotable about a pivoting axis, actuating portion, wherein a lever of the actuating arm is configured to be releasably connected to the at least one actuating portion.

15. An item of furniture comprising a furniture carcass, a furniture part movably supported relative to the furniture carcass, and at least one furniture drive according to claim 1, wherein the base body of the at least one furniture drive is fixed to the furniture carcass, preferably to and/or within a sidewall of the furniture carcass, and the movably supported furniture part is fixed to the actuating arm of the at least one furniture drive, preferably via a fastening interface.
